(19) United States
(12) Patent Application Publication
(10) Pub. No.: US 2011/0140925 A1
(43) Pub. Date: Jun. 16, 2011

(54) Automated warning system for waterski boats

(76) Inventor: Walter Dea McDonald, Mesa, AZ (US)

(21) Appl. No.: 12/653,291

(22) Filed: Dec. 11, 2009

(51) Int. Cl. G08B 23/00; H04B 1/034; G09F 17/00; B63B 45/04

(52) U.S. Cl. 340/984; 455/99; 116/173; 116/26; 340/331; 116/303

(57) ABSTRACT

There is provided an automated warning system which includes a receiver/controller, an actuator, one or more relays electrically connected to both the receiver and the linear actuator, a flag holder and a mechanical linkage connecting the linear actuator to the flag holder such that movement of the linear actuator causes the flag holder to move between raised and lowered positions.

### FIELD

This application relates to boating equipment and safety equipment for boats and individuals engaged in water sports.

### BACKGROUND

Many states require that boats towing waterskiers employ a brightly colored flag to alert nearby boats to the presence of the skier and/or ski rope. Beginning at the time the skier and/or the ski rope are in the water, the flag must be held in a raised position, visible to other boats, until either the skier is up on his or her skis, or the skier and/or rope are back inside the boat.

Many states further require that an observer other than the driver, located within the boat, be responsible for raising and lowering the flag. In addition to raising and lowering the flag, the observer often has other responsibilities including, but not limited to, assisting the skier in and out of the water, deploying and retrieving the ski rope, communicating the position and status of the skier to the driver, and ensuring the overall safety of the skier. Each of these responsibilities is time sensitive and must be coordinated with both the skier and the driver. As such, the observer often finds that manually deploying and constantly holding a ski flag in the raised position hinders his or her ability to perform the other responsibilities.

It should be understood that the same regulations generally apply equally to all water sports in which a person enters the water surrounding a watercraft including, but not limited to, wakeboarding, tubing, knee boarding and swimming.

In view of the foregoing there is a need for an observer-activated system for maintaining the flag in a visible or otherwise raised position while a person and/or a rope are in the water and maintaining the flag in a stowed or otherwise lowered position while the person is visibly atop the surface of the water or within the boat. The present invention addresses one or more of these needs.

### SUMMARY

According to one embodiment a warning system includes a receiver/controller which receives a signal and in response activates an actuator via one or more relays. The actuator is connected to a flag holder via a mechanical linkage. Energizing the actuator causes a shaft of the actuator to retract and further causes the flag holder to move from a lowered position to a raised position. Later energizing the actuator causes the shaft to extend, further causing the flag holder to move from a raised position to a lowered position.

According to another embodiment, the mechanical linkage and flag holder are configured such that energizing the actuator causes the shaft of the actuator to retract and further causes the flag holder to move from a raised position to a lowered position. Later energizing the actuator causes the shaft to extend, further causing the flag holder to move from a lowered position to a raised position.

According to another embodiment, the warning system further includes a transmitter for transmitting one or more discrete signals to a receiver/controller.

According to a further embodiment, the warning system further includes an enclosure for surrounding components of the system.

According to yet another embodiment, the warning system includes a strobe light positioned atop the system.

Other independent features and advantages of the automated warning system will become apparent from the following detailed description, taken in conjunction with the accompanying drawings which illustrate, by way of example, the principles of the invention.

### BRIEF DESCRIPTION OF DRAWINGS

FIG. 1 is a schematic view of the automated warning system, according to one embodiment, wherein the flag holder is in a raised position;

FIG. 2 is a further schematic view of the automated warning system, according to the embodiment of FIG. 1, wherein the flag holder is in a lowered position;

FIG. 3 is a front view of the automated warning system according to one embodiment;

FIG. 4 is a cutaway view of the automated warning system according to one embodiment; and

FIG. 5 is top cutaway view of the automated warning system according to one embodiment.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding Background or Summary or the following Detailed Description. Reference will now be made in detail to exemplary embodiments, examples of which are illustrated in the accompanying drawings. Wherever possible, the same reference numbers will be used throughout the drawings to refer to the same or like parts.

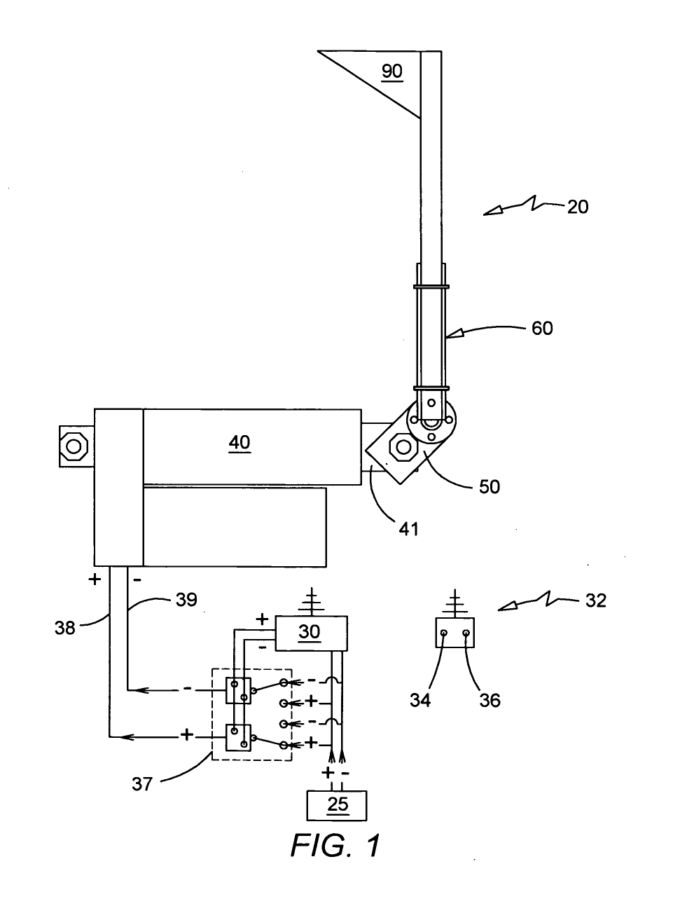

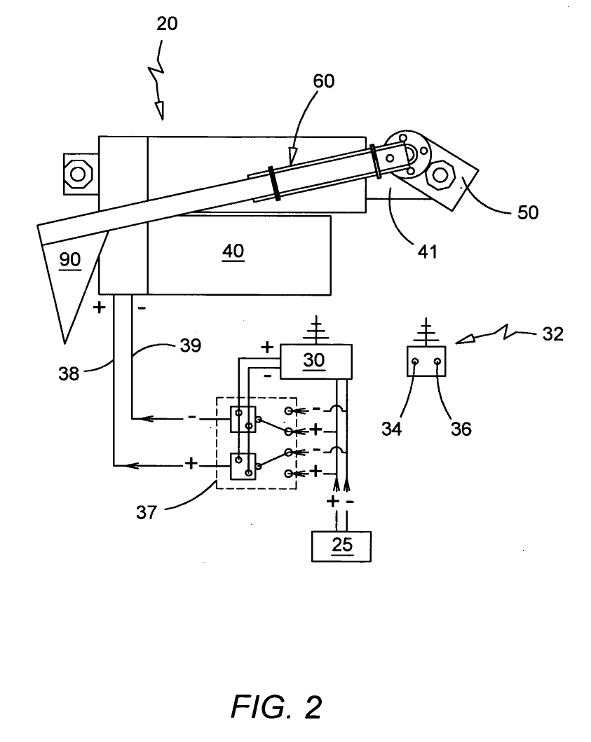

As shown in FIGS. 1 and 2, a warning system 20 has a receiver/controller 30, an actuator 40, a mechanical linkage 50, and a flag holder 60. The receiver/controller 30 is electrically connected to one or more relays 37 such that a control signal may be transmitted to the one or more relays by the receiver/controller 30. The one or more relays 37 are further electrically connected to the actuator 40 such that the one or more relays 37 may energize the actuator 40 as set forth more fully below. The actuator 40 is connected to the flag holder 60 by the mechanical linkage 50 such that the movement of a shaft 41 of the actuator 40 results in movement of the flag holder 60, and a flag 90, if attached.

The receiver/controller 30 may be any component designed to operate the one or more relays 37 to provide power to the actuator 40. Each relay 37 is preferably a latching relay such that the actuator 40 receives a constant positive or negative electrical signal rather than a pulse or momentary electrical signal. Further, each relay 37 is preferably a multiple pole multiple throw magnetic latching relay, however any relay 37 is within the inventive concept. The receiver/controller 30 and the one or more relays 37 may be separate components or they may be combined and treated as a single component. According to one embodiment, the receiver/controller 30 is a radio frequency receiver/controller 30 to receive a signal transmitted by a radio frequency transmitter 32. By way of example only, a 2 channel radio frequency transmitter and receiver board, such as the type manufactured by Annex Depot, Inc. (Model No. ERF-2A433-MT) is appropriate for use in this device.

The actuator 40 converts an electrical signal to physical movement, thereby causing the flag holder 60 to move between a lowered position and a raised position. For purposes of this Disclosure, the raised position is a generally vertical position, and the lowered position is any position at or below a generally horizontal position. The actuator 40 is preferably a linear actuator. Further, the linear actuator 40 is preferably a 12 volt direct current motor operated linear actuator, although any linear actuator 40 is within the inventive concept. According to one embodiment, the linear actuator 40 further includes a limit switch designed to prevent the shaft 41 of linear actuator 40 from moving more than a predetermined distance. According to one embodiment a preferred distance of extension and retraction is approximately one inch. Again, by way of example only, a one inch stroke, 12 volt direct current linear actuator manufactured by Firgelli Automations is sufficient for use in this device. Alternatively, a direct drive step motor or a motor operated gear box with indirect drive may be used in place of linear actuator 40 to convert the electrical signal into physical movement.

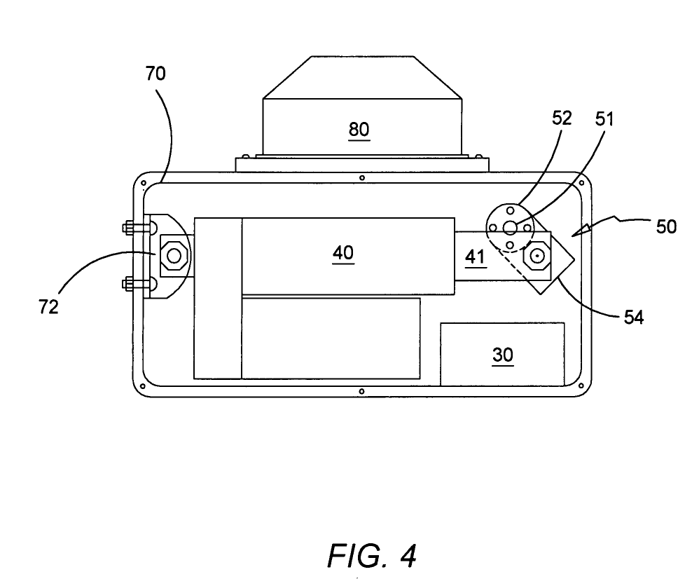

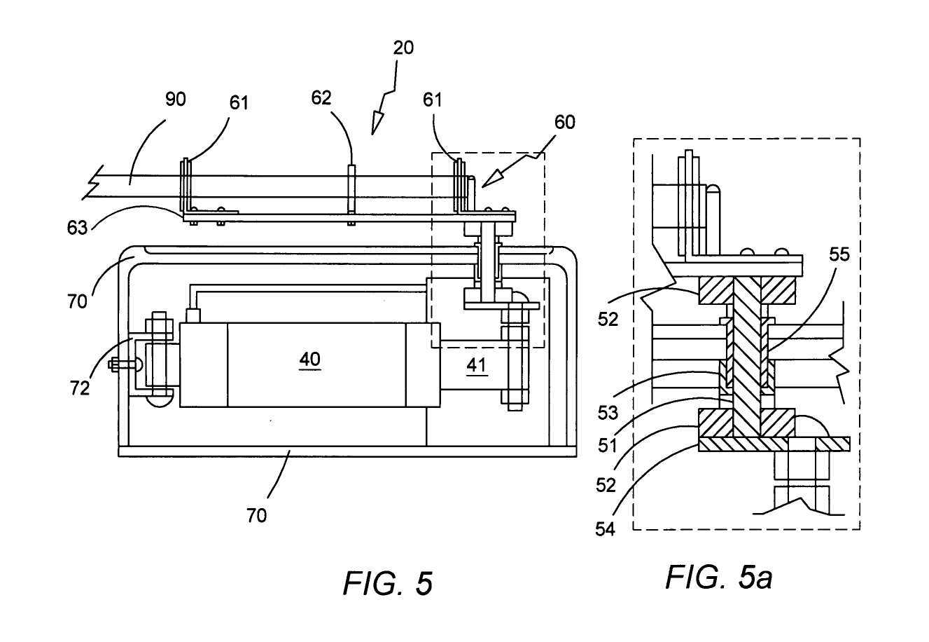

The mechanical linkage 50 is secured to the shaft 41 of the linear actuator 40 and to the flag holder 60. The mechanical linkage 50 can be any assembly that effectively connects the linear actuator 40 to the flag holder 60. According to one embodiment, as shown in FIGS. 4 and 5, the mechanical linkage 50 is made up of an axle 51, at least two set-screw hubs 52, one set-screw collar 53, one linkage armature 54 and a bushing 55. Alternatively, for example, the mechanical linkage 50 may consist of at least two die-cast aluminum armatures mounted on one stainless steel axle and bushing with two set screws.

The flag holder 60 may be any device capable of grasping, retaining and supporting the flag 90. The flag holder 60 may be a device that allows the flag 90 to be attached to and detached from the device without permanent fasteners. According to one embodiment, for example, the flag holder 60 is a quick release device which consists of two rubber lined flag pole supports 61 and a spring loaded friction clip 62, each secured to a flag armature 63. Alternatively, the flag holder 60 may be a device that permanently secures the flag 90.

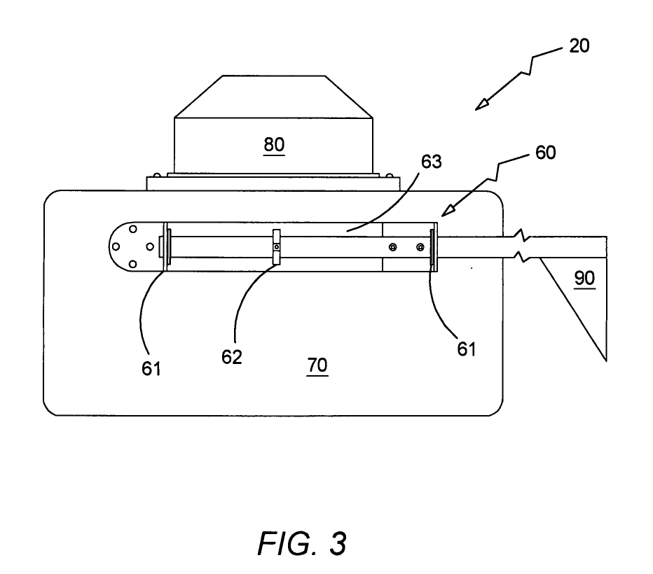

According to another embodiment, the warning system 20 further has an enclosure 70. The enclosure 70 is preferably of plastic or metal, but may be anything that adequately encloses various components of the invention. According to one embodiment, as shown in FIG. 4, the enclosure 70 consists of a compartment for containing the linear actuator 40, the receiver/controller 30, and the one or more relays 37. According to another embodiment (not pictured), the enclosure 70 may further enclose a power supply 25. According to the embodiment of FIG. 3, the flag holder 60 is preferably located on the exterior of the enclosure 70. The flag holder 60 is held in place by mechanical linkage 50, which is located partially interior and partially exterior to the enclosure 70. Specifically, the axle 51, which connects the linkage armature 54, located within the enclosure 70, and the flag armature 63, located outside the enclosure 70, extends through the wall of the enclosure 70. Some implementations of the warning system 20 may further require that the enclosure 70 is moisture resistant. Further, as shown in FIG. 4, the linear actuator 40 may be secured to the enclosure 70 with an actuator pivot bracket 72.

As shown in FIGS. 3 and 4, the warning system 20 may further include a light 80 designed to serve as an additional method of alert to surrounding watercraft. The light 80 is preferably a strobe light, although any light is within the inventive concept. The light 80 is preferably affixed to the top of the warning system 20 such that it is most visible to surrounding watercraft.

Referring again to FIG. 1, while in use, power is supplied to the linear actuator 40 and the receiver/controller 30. When the user desires to raise the flag, the user sends a first signal by pressing a first button 34 on the transmitter 32. The transmitter 32 will transmit a discrete signal to the receiver/controller 30. The receiver/controller 30 will then send an electrical signal to the relay 37 to apply a positive voltage on a first wire 38 of the linear actuator 40 and apply a negative voltage on a second wire 39 of the linear actuator 40. The positive and negative circuits will energize the linear actuator 40, causing the shaft 41 of the linear actuator 40 to retract. At a retraction of a preset length, a limit switch within the linear actuator 40 will deenergize the linear actuator 40. The retraction of the shaft 41 causes the mechanical linkage 50 to rotate the flag holder 60 and the flag from a lowered position to a raised position.

According to another embodiment, the positive and negative circuits from the relay 37 also energize the light 80.

When the user desires to lower the flag, the user sends a second signal by pressing a second button 36 on the transmitter 32. The transmitter 32 will transmit a discrete signal to the receiver/controller 30. As shown in FIG. 2, the receiver/controller 30 will send an electrical signal to the relay 37 to apply a negative voltage on the first wire 38 of linear actuator 40 and apply a positive voltage on the second wire 39 of linear actuator 40. The reversed positive and negative polarity circuits will energize the linear actuator 40 and the shaft 41 will extend. At an extension of a preset length, a limit switch within the linear actuator 40 will deenergize the linear actuator 40. The extension of the shaft 41 causes the mechanical linkage 50 to rotate the flag holder 60 and flag from a raised position to a lowered position.

According to another embodiment, the reversed polarity of the relay 37 also deenergizes the light 80.

According to yet another embodiment, but by the same general principles, the mechanical linkage 50 and flag holder 60 are configured such that energizing the linear actuator 40 causes the shaft 41 of the linear actuator 40 to retract and further causes the flag holder 60 to move from a raised position to a lowered position. Later energizing the linear actuator 40 causes the shaft 41 to extend, further causing the flag holder 60 to move from a lowered position to a raised position.

The disclosed embodiments provide advantages over the prior art. For example, the disclosed embodiments allow one or more observers to assist the skier in and out of the water and deploy and retrieve the ski rope, among other things, while ensuring that the flag is maintained in a raised and preferably visible position. More importantly, the disclosed embodiment allows the user to comply with state law, which requires that an observer control the raising and lowering of the warning flag and not the driver, skier or an unmanned electrical and/or mechanical device.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to a particular embodiment disclosed as the best mode contemplated for carrying out this invention, but that the invention will include all embodiments falling within the scope of the appended claims.

1. An automated warning system, comprising:
an actuator;
one or more relays connected in power delivery relation to the actuator;
a receiver/controller connected in controlling relation to the one or more relays; and
a flag holder;
wherein the flag holder is connected to the actuator by a mechanical linkage for movement by the actuator.

2. The automated warning system according to claim 1, further comprising an enclosure.

3. The automated warning system according to claim 2, wherein the enclosure is moisture resistant.

4. The warning system according to claim 2, wherein the enclosure is made of plastic or metal.

5. The automated warning system according to claim 1, further comprising a light positioned atop the system.

6. The automated warning system according to claim 5, where in the light is a strobe light.

7. The automated warning system according to claim 1, further including a transmitter for transmitting a signal to the receiver/controller.

8. The automated warning system according to claim 7, wherein the receiver/controller includes a radio frequency receiver and the transmitter is a radio frequency transmitter.

9. The automated warning system according to claim 1, wherein the one or more relays are latching relays.

10. The automated warning system according to claim 1, wherein the actuator is a linear actuator.

11. An automated warning system, comprising:
a first means for receiving input from the user;
a second means for converting the user input to an electrical signal;
a third means for converting the electrical signal to motion;
a fourth means for supporting a flag in both raised and lowered positions;
a means for connecting the third means and the fourth means, whereby the motion created by the third means causes the fourth means to move between said raised and lowered positions.

12. An automated warning system according to claim 11, wherein the third means for converting the electrical signal to motion comprises a motor operated linear actuator.

13. An automated warning system, comprising:
a radio frequency transmitter;
a radio frequency receiver/controller;
a motor operated actuator;
a double pole double throw magnetic latching relay, electrically connected to both the radio frequency receiver/controller and the motor operated actuator;
a flag holder; and
a mechanical linkage connecting the flag holder to the actuator.

14. An automated warning system according to claim 13, wherein the mechanical linkage further comprises a shaft, two or more set screw hubs, one set screw collar and a linkage armature.

15. An automated warning system according to claim 13, wherein the actuator is a linear actuator.

16. An automated warning system according to claim 13, further including a moisture resistant enclosure.

17. An automated warning system according to claim 13, further including an enclosure made of metal or plastic.

18. A method for alerting nearby watercraft, comprising:
providing a system according to claim 1;
placing the system upon a watercraft in a location that is visible to surrounding watercraft;
using the system to raise and lower a flag.

19. A method of equipping a watercraft to alert other watercraft, comprising:
providing a flag holder adapted to hold a flag;
coupling an electrically operated actuator to the flag holder by a mechanical linkage for movement of the flag from a lowered position to a raised more visible position;
providing at least one relay for application of electrical power from a power source to the actuator;
providing a receiver/controller in controlling relation to the at least one relay; and
providing a transmitter for communicating activating signals from the transmitter to the receiver/controller.

20. A method according to claim 19, wherein the actuator is a motor operated linear actuator.
